(19) United States
(12) Patent Application Publication
(10) Pub. No.: US 2005/0037138 A1
(43) Pub. Date: Feb. 17, 2005

(54) Process for partial coating of printed circuit boards and device for carrying out the process

(76) Inventor: Wolfgang Klingel, Friolzheim (DE)

Correspondence Address: Stephan A. Pendorf;Pendorf & Cutliff, 5111 Memorial Highway, Tampa, FL, 33634-7356, US

(21) Appl. No.: 10/897,458

(22) Filed: Jul. 23, 2004

(30) Foreign Application Priority Data
Aug. 11, 2003 (DE) 103 37 137.0

(51) Int. Cl. B05D 5/12; B05C 3/00

(52) U.S. Cl. 427/96.1; 118/400

(57) ABSTRACT

In a process for partial coating of printed circuit boards (11) with an initially liquid coating material, a coating tool (12) is used that can be flooded with the coating material, which has the basic shape of a basin with coplanar free frontal surfaces (16/1 N) which has basin internal space bordering casing walls (14/1 N), against which the printed circuit boards can be pressed liquid-tight with their side to be coated facing the internal space. For coating, the tool is brought into the position, in which the free frontal surfaces of the basin casing walls of the coating tool and the printed circuit board lying sealingly thereon run horizontally and in this position are filled with coating material to the extent that the vertical distance d of the fluid level (17) from the surface of the printed circuit board (11) to be coated is very much smaller than the largest lateral breadth B of the coating surface of the printed circuit board (11) and for example is 1/100 to 1/10 thereof; thereafter the coating tool (12), with printed circuit board (11) pressed thereagainst, is pivoted about a pivot angle α back and forth at least one time in alternative directions about the axis (19), which angle is significantly greater than the lower value defined by the equation tgα=2d/B; following the wetting of the surface to be coated of the printed circuit board the coating tool is again brought to the position with horizontal orientation of its free frontal surfaces and then the liquid level is maintained for a minimum time interval with narrow distance from the printed circuit board (11) and then the coating tool is lowered with slow speed until a minimum separation of the liquid level is achieved from the lowest lying element of the coating surface of the printed circuit board.

### BACKGROUND OF THE INVENTION

1. Field of Invention

The invention concerns a process for partial coating of printed circuit boards with a protective coating material which is initially in the liquid state using a coating tool that can be flooded with the coating material, the coating tool having the basic shape of a basin with co-planar free frontal surfaces of the basin inner space bordering basin casing wall, against which the printed circuit board, with its side to be coated facing the internal space, can be pressed liquid-tight, and with further generic characteristics as set forth in the precharacterizing portion of patent claim 1.

2. Related Art of the Invention

One process of this type is described in German Patent DE 42 11 342 C2.

In the known process a coating tool is used, of which the internal space is divided into two chambers by a transverse wall, which wall is somewhat lower than the casing wall areas transitioning into upper end surfaces coplanar with each other, which two chambers are sequentially floodable with a liquid coating material. A transition gap is bordered by the upper edge of the inner transverse wall and the printed circuit board to be coated, which is pressed against the upper edges of the casing wall segments, through which gap coating material can flow and following the complete flooding of the first chamber can flow out of the first chamber and into the second chamber and can again flow out of this. For coating the printed circuit board the coating tool is tilted several degrees about a horizontal axis running at the height of the tool floor and which runs along the lower edge of the transverse wall, whereupon that respective chamber, in which the overflow gap is the highest point, is flooded, until the coating material overflows over the upper edge of the intermediate wall into the adjacent chamber, from which it can exit via a drain or outflow. Thereafter the mold tool is tilted into that position in which the upper edge of the intermediate wall forms the highest lying part of the other partial chamber and thereupon fills this, while—controlled by valves—the coating material can flow out of the previously flooded chamber. In this second tilt position the now flooded part of the printed circuit board is coated, wherein in the area of the overflow gap an overlap area of the flooded partial coating areas of the printed circuit boards is produced.

This known type of protective material coating of printed circuit boards can without difficulty be integrated into a multistage production process, since there is an easy way of supplying the printed circuit boards “from above” to the coating station at which this known process is employed. It must, however, be taken into consideration that the division of the coating process into two flood stages, connected with the necessity that beginning with the point in time at which the fluid level contacts the respective partial surface to be coated, the flooding must be carried out slowly, in order to preclude formation of bubbles at the slanted coating surface, and in general to avoid ventilation problems, which are associated with significant time requirements.

On the other hand it is also known (DE 40 12 903 A1) to use a coating basin for protective coating of printed circuit boards, which contains a sufficient material supply for the coating of a large number of printed circuit boards; the respectively to the coated printed circuit board is seated on the end wall of the basin casing, while the basin is held in a position, in which the coating material has collected on the floor of the basin. After the printed circuit board is seated and is pressed with sufficient force against the end wall of the basin casing, the functional unit formed by the board and the coating wall is so tilted, that the printed circuit board at the same time forms the floor of the chamber and the coating material flows onto the parts of the printed circuit board to be coated and completely wets these parts. Thereafter the coating basin together with the board can again be rotated or tilted to that position in which the basin floor is located below the printed circuit board, so that superfluous coating material can again flow back to the lower area of the chamber.

This further known type of coating of printed circuit boards is preferably employed for the partial coating of printed circuit boards in such a manner that a plurality of partial areas, which can be spatially isolated from each other, are to be coated, which according to this process however can all be “simultaneously” coated rapidly and with even quality, wherein also no ventilation problems occur. However, this known process, which requires relatively frequent refilling, can be integrated only with relatively great effort into a complex “in-line” production process and thus is rationally employable only in the case that the coating process can be carried out independent of the remaining production processes.

### SUMMARY OF THE INVENTION

It is thus the task of the invention to provide a process of the above-described general type, which can be integrated without considerable effort into a complex manufacturing process and which makes possible high product quality by avoiding ventilation problems.

This task is solved in accordance with the basic idea of the invention by the characterizing portion of Patent claim 1.

In accordance therewith the basin-shaped, printed circuit board covered, shaped tool is brought into a starting position, in which the free frontal surfaces of the basin casing walls and the printed circuit board lying sealingly thereagainst are oriented horizontally and is then filled with coating material to the extent until the vertical separation d of the surface level of the liquid from the surface of the board to be coated is so small, that it is approximately 1/100 to 1/10 of the largest lateral dimension B of the surface to be coated. Thereafter the coating tool is pivoted about a predetermined horizontal axis until the surface areas in the one as well as the other pivot end-position result in a complete wetting of the surface to be coated. Thereby the coating tool can be pivoted back and forth multiple times and also about two different axes, preferably running perpendicular to each other.

In order that a sufficient overlapping breadth is achieved of the partial surfaces coatable at the pivot end-positions, the pivot angle α should be significant, for example 20 to 50% greater, than a lower gate or barrier, which are defined by the formula or relationship
tgα=2d/B.

In principle it does not matter whether the respective pivot axis run outside of the spatial area covered over by the floor surface of the shaped tool or within this, wherein however for operative reasons—accessibility of the coating basin from above—it can be particularly useful when the pivot axis is below the plane demarked or defined by the smaller or narrow end surfaces of the basin casing segments.

For a rapid dripping of excess coating material it can be particularly advantageous when the liquid level in the coating tool, after coating of the printed circuit board, is stepwise lowered in such a manner that construction components of various vertical dimensions can remain in contact with the liquid level for short drip-times, in order to use the surface tension forces existnig in a coating fluid in order to accelerate the running off of excess liquid.

A device suitable for the automated carrying out of the inventive process in a simple design is set forth in the characterizing portion of of claim 8, which can be modified for increasing capacity as required according to the characteristics set forth in claim 9.

### BRIEF DESCRIPTION OF THE DRAWINGS

Further details of the invention can be seen from the following description of the inventive process on the basis of a device suitable for carrying out thereof as illustrated in the figures. There is shown:

FIG. 1a an exemplary embodiment of a device operable in accordance with the inventive process for coating of printed circuit boards with a basin-shaped coating tool in schematic simplified representation,

FIG. 1b the coating tool of the device according to FIG. 1a in schematic simplified top view,

FIG. 2 a schematic simplified view of the coating device according to FIG. 1a in the direction of arrow II in FIG. 1a and

FIG. 3 a schematic simplified view of the coating tool of the device according to FIGS. 1a and 2 in the direction of the arrow III of FIG. 1b, in alternative tilt positions for illustrating the alternative tilt positions of the pivot process.

### DETAILED DESCRIPTION OF THE INVENTION

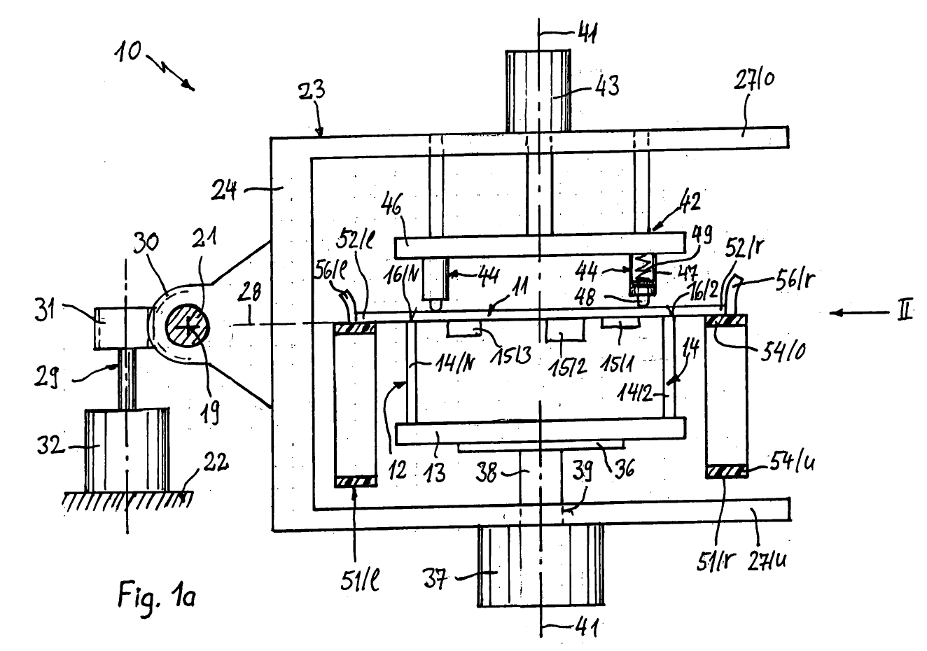

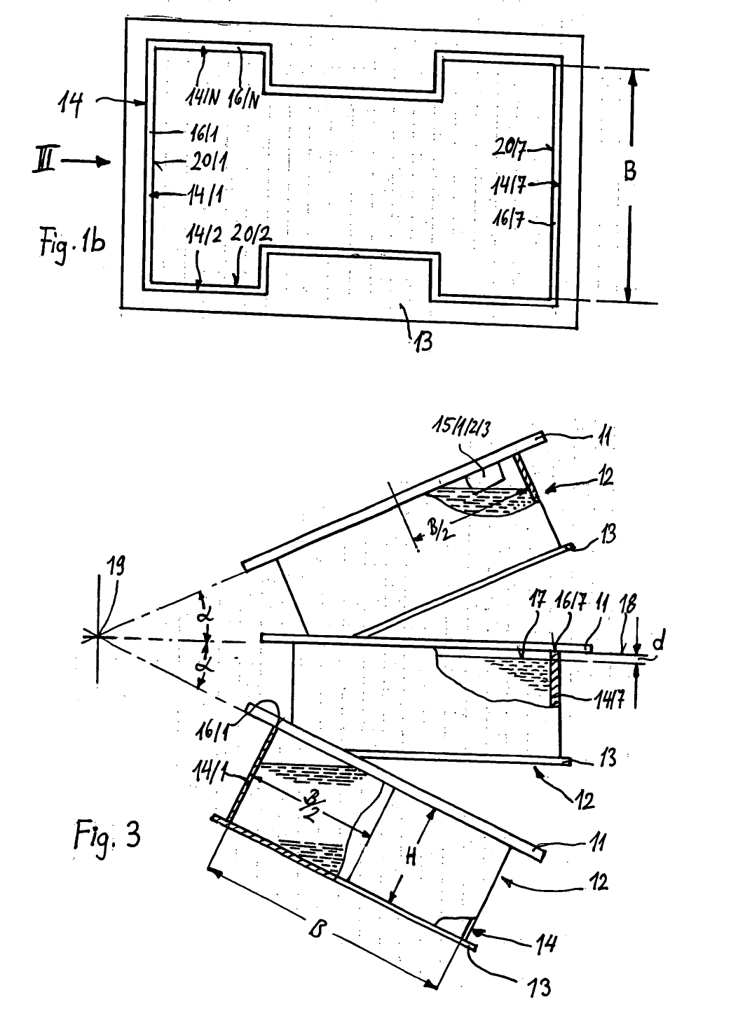

The purpose of the coating device, indicated overall with reference number 10 in FIGS. 1a and 2, respectively, is the rational application of protective coating layers of high quality upon printed circuit boards 11, which must be provided with protective layers of electrically insulating material for protection of electronic components 15/1 through 15/3 located on the printed circuit boards as well as for protection of the printed circuit boards themselves.

The device makes possible also a partial coating with protective material in such a manner that at least edge-areas of a printed circuit board 11, and in certain cases also partial areas surrounded by coated surface areas of the board, remain free of coating.

For this purpose the coating tool, designated overall with reference number 12, is provided in the form of a basin shaped mold cup, which includes at least one casing wall 14 which is closed and projects perpendicularly up from the base plate 13, of which the planar or curved casing segments 14/1 through 14/N, measured from the base plate 13, have the same height H, so that their free frontal surfaces 16/1 through 16/N run co-planar to a plane parallel to the base plate 13.

The casing wall 14 is so designed, that the contour of the inner boundary edges 20/1 through 20/N (FIG. 1b) of the free frontal surfaces 16/1 through 16/N of the adjoining casing wall segments 14/1 through 14/N corresponds to the contour of the periphery of the surface of the printed circuit board 11 to be coated. Herein for simplification it is presumed that the coating surface is, in the mathematical sense, simple contiguous, that is, to be completely coated within its edge contour.

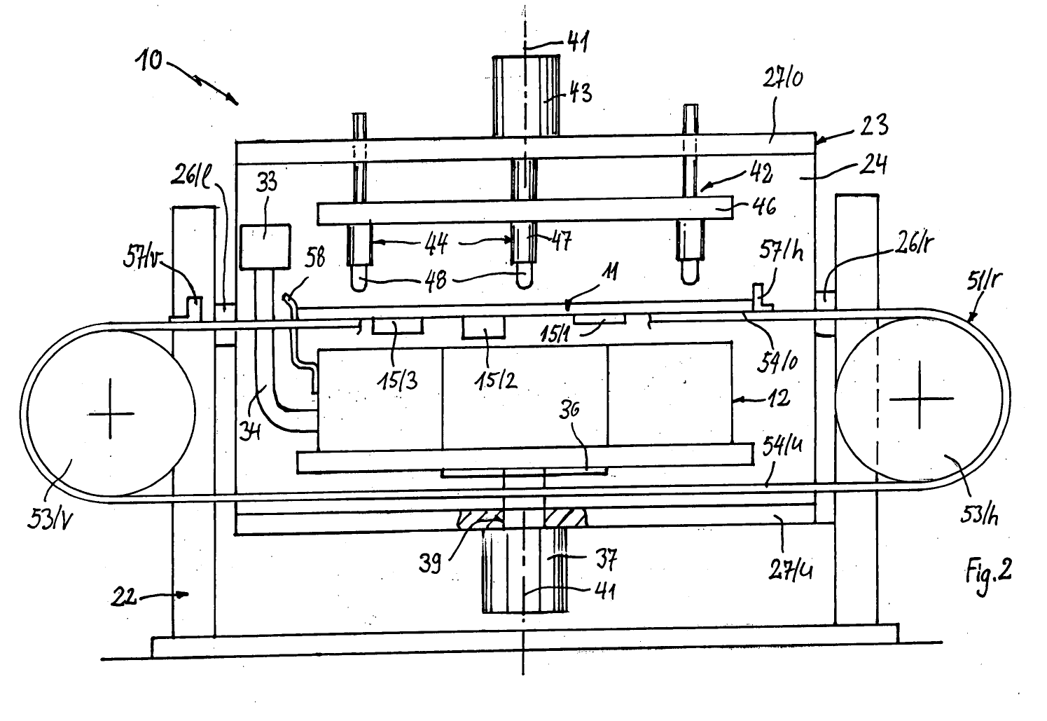

Before further details of the coating device 10 will be explained, first the basic principle of the process is explained with reference to FIG. 3, in which a partial or fully automatic procedure with the coating device 10 is illustrated.

To prepare for a coating process the coating tool 12 is first brought into that position, in which the entire plane 18 of the free frontal surfaces 16/1 through 16/N of the basin liner segment 14/1 through 14/N runs horizontally.

Thereafter the coating tool 12 is filled with liquid protective coating material to the extent that the liquid surface level 17 (FIG. 3) is located at a vertical separation d from the common plane 18 of the free frontal surface 16/1 through 16/N of the basin liner segments 14/1 through 14/N; thereby it is—implicitly—presumed, that the separation d is very much smaller than the lateral dimension B of the coating tool, that this has a sectional plane, which runs perpendicular to the axis 19, in order that the coating tool 12 is pivoted in alternative directions.

“Very much smaller” is herein to be understood that the separation d has a value of between 1/25 and 1/100 of the lateral dimension B.

At the latest, following the mentioned level of filling—distance d of the liquid surface level from the common plane 18 of the free frontal surfaces 16/1 through 16/N—is established, the printed circuit board 11 is pressed with sufficient pressure against the free frontal surfaces 16/1 through 16/N of the basin casing segments 14/1 through 14/N, such that the flat internal space area of the coating tool 12 extending between the side of the printed circuit board 11 to be coated and the liquid surface level is closed off liquid-tight.

In this configuration the coating tool 12 is pivoted at least once about the pivot axis 19 in the clockwise sense and once counterclockwise, each time about an angle having a minimum value α, which is sufficient, that in each of the two alternative pivot end positions the printed circuit board 11 is wetted by coating material for more than the half of the lateral dimension B of the coating tool 12, so that in the central area of the side of the printed circuit board 11 to be coated, an overlap in the respective end position wetted surface areas is produced and a complete coating of the printed circuit board is achieved.

Thereafter the coating tool 12 is again pivoted into its “horizontal”—neutral—center position, in which coating material, which is henceforth excess, can drip off from the coated side of the printed circuit board 11 into the coating material of which the level is in close proximity.

“Close proximity” in the above sense means that the distance of the liquid surface level from the surface of the printed circuit board being coated is approximately one-half the diameter that a drop would have, if such a drop was released immediately after separation from the coating surface, in the case that it could completely develop.

In order to accelerate a dripping off of excess material from the coated printed circuit board 11, the liquid level is lowered “slowly” relative to the coating material wetted printed circuit board, in such a manner that the liquid cohesion forces acting in the coating material can be used to help pull off excess coating material. For this it can also be useful to stepwise lower the liquid level, which corresponds to the height differential of construction elements 15/1 through 15/3, from which likewise coating material must drip off, which is supported thereby, that the liquid level is maintained for suitable drip-forming periods in the immediate vicinity of the free surface of the coating-material coated building components.

For an acceleration of the dripping off process it can also be useful, after a first phase of the dripping in the course of which the printed circuit board is still held in close proximity to the free frontal surfaces 16/1 through 16/N of the casing wall segment of the coating tool, to unburden the printed circuit board 11, for example to lift the down-holders 44 from the coating tool, such that within the coating tool the formation of a vacuum is avoided.

In the special illustrated embodiment of the inventive device 10 selected for explanation, the pivot axis 19 is demarked by the central axis of a longitudinally extending cylindrical bolt 21, which is a component of a machine framework which is essentially schematically indicated and indicated overall with reference number 22, which is provided with a—not shown—adjusting device, with which the machine framework 22 (FIG. 2) can be set to the exact horizontal orientation. For the illustrative example it is presumed that the horizontal orientation of the pivot axis 19 remains established after an adjustment with respect thereto of the machine framework 22, so that a device for resetting is not necessary.

On the—framework fixed—bolt 21 is mounted a carrier referenced overall with reference number 23 and having an up-and-down pivotable U-shaped design, which on the outside is provided with a planar surface bordered yoke shank 24 with two mounts 26/l and 26/r, which are rigidly connected with the carrier 23, for example welded thereto, wherein the yoke shank 24 extends evenly between the mounts 26/1 and 26/r.

The carrier 23, of which the profile shanks 27/o and 27/u, which run parallel to each other, run also at right angles to the yoke shank 24, is pivotable motor controlled, in the view seen in the representation according to FIGS. 1a and 3, between an “upper” end position in which the profile center plane 28 contained in the pivot axis 19, running between the parallel shanks 27/o and 27/u, runs diagonally rising, and a lower end position, in which this center plane, viewed from the axis 19, runs diagonally downward.

The electric motor driven actuator or final control element provided for this purpose is shown schematically in FIG. 1 by a threaded drive 29, of which the worm gear is a sector-shaped gear or pinion 30 of one of the eye plates of the carrier-fixed mounting or bearing eyes 26/l or 26/r is formed, and which shank 31 is steerably drivable via an electric motor 32 in reversible directions.

The respective end positions can—in principle—be defined by the suitable adjustment of not shown end position switches.

Further, a likewise not shown position-sensor is provided, which produces for the “middle” position of the carrier 23, in which this middle plane 21 runs horizontally, a characteristic signal, which is useful for starting and temporarily maintaining the middle position. A sensor of this type could have many forms, for example a light switch or a digital optoelectronic path measuring system, for example a high resolution glass gauge or scale system.

For detecting the level of fill of the coating material in the coating tool 12 or as the case may be the vertical separation d of the liquid level 17 from the common plane 18 of the upper narrow frontal surfaces 16/1 through 16/N of the basin casing segments 14/1 through 14/N there is provided a fiber optic light sensor 33 indicated essentially schematically, which generates a signal from a measurement of the intensity of the test light reflecting at the liquid surface level 17, which is a measurement value for the separation of the liquid surface level from the light detector, so that, in the case of a known arrangement of the detector system of the light sensor 33 and the illumination geometry, it is possible from the signal level to make a conclusion regarding the level of the liquid. The light sensor 33 is preferably provided on the free end of a riser or stand pipe 34 which, in communication with the printed circuit board covered internal space of the coating tool 12, is located outside this space and in lateral separation from the edge of the printed circuit board to be coated.

It is readily apparent, that the position and distance sensor system explained essentially on the basis of its function can also be realized in other sensor types other than those selected for this illustrative explanation. For example, adjustable mercury switches are suitable as pivot angle limitation switches, which produce an electrical contact beginning at an adjustable angular position, and also any type of ultrasound sensor can be employed as the distance sensor, or a capacity reactance sensor, of which the capacity varies with the level of fill to be detected. It is well within the skill of the art to select or design a sensor device to meet any requirement.

The coating tool 12, of which the design must be matched to the specific product, is securable in the central area of the U-shaped profile carrier 23 to a carrier part 36, which is provided moveable up and down on the “lower” profile shank 27/u of the U-profile carrier 23. A double acting pneumatic cylinder 37 provided for this purpose is provided on the lower side of the shank 27/u; a piston rod 38 extends through the bore 39 of the lower profile shank 27/u and is secured against rotation about the central axis 41 of the pneumatic cylinder 37 by means of a not separately shown guide element, for example a spring wedge or a rod extending from the plate 36 which extends through an opening of complimentary cross-section to the lower profile shank 27/u.

In analogous manner a downholder system, referenced overall with reference number 42, is provided at the upper cross-shank 27/o, for the movement control of which a double-acting pneumatic cylinder 43 is provided coaxially with the cylinder 37 for the axial movement of the coating tool 12.

The downholder system 42 includes a number—six in the illustrated embodiment—of downholders 44, which on the lower side are provided on the bottom side of a carrier plate 46 provided moveably on the lower side of the upper profile shank 27/o and have cylinders 47 securable thereto, in which downwardly extending lifters or rams or slides 48 are provided axially moveable, which can be pushed back into the cylinders 47 against the force of a weakly pre-tensioned spring and are prevented from falling out of the respective shells 47 by abutments or stops.

By the combined lifting of the coating tool 12 and the printed circuit board 11 supported upon the casing wall free frontal surfaces, and the lowering of the downholder system 42, until the lifters 48 thereof come into contact with the free upper side of the printed circuit board 11 and thereby against the increasing return spring force of the downholder springs 49 are pushed into the shells 47—controlled along the way—the pressure force is adjustable in defined manner, with which the side of the printed circuit board 11 to be coated can be pushed in sealing engagement or lying against with the free narrow frontal surfaces 16/1 through 16/N of the liner segment 14/1 through 14/N of the coating tool 12, that is, the coating device 10 can be brought into that respective configuration in which the coating process can be performed or executed by pivoting of the U-profile carrier 23 about the pivot axis 19.

The transport system suitable for an automated carrying out of the coating process and shown in FIGS. 1 and 2 in substantially simplified schematic representation includes in this special design two continuous conveyor belts 51/l and 51/r (FIG. 1a), which are provided on both sides of the coating tool 12 in symmetrical arrangement with respect to the “vertical” longitudinal center plane of the carrier-U-profile 23 in symmetric arrangement with regard to the parallel to the yoke shank 24 of the carrier-U-profile 23 running “vertical” longitudinal center plane of the carrier-U-profile 23, in such a manner, that the printed circuit board 11 with longitudinal edge areas 52/l and 52/r along the sides can be laid upon the respective conveyor belt 51/l or as the case may be 51/r and be moveable along by the transport movement of the conveyor belts over the coating tool 12 and be positioned in proper orientation with respect thereto.

For this, the conveyor belts 51/l and 51/r, which are laid over a pair of redirection rollers 53/v and 53/h and have horizontal running branches or offshoots 54/o and 54/u running there between, provided with essentially schematically indicated centering elements 56/l and 56/r, which engage with the longitudinal edges of the printed circuit boards, as well as with take-along elements 57/v and 57/h, which can grip or engage the printed circuit boards 11 close to the edges at the transverse edges, so that these can be advanced or retracted, depending on the direction of movement of the conveyor belts 51/l and 51/r. Preferably at least one abutment element 58 is provided on the shaped tool which engages between the conveyor belts 51/l and 51/r with one of the transverse edges of the respective printed circuit board 11 and thereby prevents a transport movement of the same beyond the abutment element 58, even when the centering plate is held between the shaped tool and the downholders frictionally with a minimum force.

By the combined movement control of two pneumatic cylinders 37 and 43 the printed circuit board 11 can be lifted for the precise positioning and/or for a delivery or a further transportation from the or by the conveyor belts.

1. A process for (partial) coating of printed circuit boards (11) with a coating material which is initially liquid using a coating tool (12) that can be flooded with the coating material, which has the basic shape of a basin with coplanar free frontal surfaces (16/1 N) which has basin internal space bordering casing walls (14/1 N), against which the printed circuit boards can be pressed liquid-tight with their side to be coated facing the internal space, wherein the coating tool is pivotable about at least one horizontal axis (19) and is thereby adjustable between at least two different pivot positions in which wetting, which enables coating, occurs by the flooding of complimentary partial surfaces of the printed circuit board to be coated, wherein:
a) the coating tool is brought into a position, in which the free frontal surfaces of the basin casing walls (14/1 through 14/N) of the coating tool (12) and the printed circuit board (11) lying sealingly thereon run horizontally and in this position are filled with coating material to the extent that the vertical distance d of the fluid level (17) from the surface of the printed circuit board (11) to be coated is very much smaller than the largest lateral breadth B of the coating surface of the printed circuit board (11) and for example is 1/100 to 1/10 thereof;
b) thereafter the coating tool (12), while the printed circuit board (11) is held pressed thereagainst, is pivoted about a pivot angle α back and forth at least one time in alternative directions about the axis (19), which angle is significantly greater than the lower value defined by the equation tgα=2d/B, and
c) following the wetting of the surface to be coated of the printed circuit board (11) the coating tool (12) is again brought to the position with horizontal orientation of its free frontal surfaces (16/1 through 16/N) and then the liquid level is maintained for a minimum time interval with narrow distance from the printed circuit board (11) and then the coating tool is lowered with slow speed until a minimum separation of the liquid level is achieved from the lowest lying element of the coating surface of the printed circuit board (11).

2. A process according to claim 1, wherein, that the coating tool (12) is pivoted multiple times back and forth.

3. A process according to claim 1, wherein the coating tool (12) is pivoted about two different axis, preferably running perpendicular to each other.

4. A process according to claim 1, wherein the respective pivot axis (19) extends outside of the spatial area covered over by the base surface of the coating tool (12).

5. A process according to claim 1, wherein the axis (19) about which the coating tool (12) is pivoted runs in a vertical central plane thereof.

6. A process according to claim 5, wherein that the axis (19) about which the coating tool (12) is pivoted is in the plane of the coating side of the printed circuit board (11).

7. A process according to claim 1, wherein the lowering of the liquid level (17) occurs stepwise, wherein the stepwise elevations of the height differential correspond to the height differential of construction components, which are being coated with protective coating.

8. A device for partial protective coating of printed circuit boards (11) with a coating material which is initially liquid, with a coating tool (12) which can be flooded with the coating material, which has the basic shape of a basin with coplanar free frontal surfaces, to which the printed circuit board (11) to be coated can be pressed liquid-tight with its side to be coated facing the internal space, wherein the coating tool is pivotable about at least one axis (19) and can be set in at least two different pivot positions, in which surface areas, which together cover over the entire coating surface, can be coated by flooding with coating material, for carrying out the process according to one of claims 1 through 7, wherein:
a) a pivot device (29) is provided, via which the coating tool (12) is pivotable motor-driven about the horizontal axis;
b) a position sensor is provided, capable of recognizing the position of the coating tool (12) corresponding to the horizontal orientation of the free frontal surfaces (16/1 through 16/N) of the coating tool and adapted to releasably maintain the coating tool in this position;
c) an automatic controlled flooding device is provided, by means of which the protective coating material can be supplied into the shaped tool and again be removed therefrom;
d) an electronic or electromechanical or an optoelectronic separation sensor device is provided, by means of which the distance of the liquid level (17) in the coating tool (12) from the coating side of the printed circuit board (11) is continuously detectable and an electronic control device is provided, which depending upon the value of the information signal derived by the sensor device, provides an automatic control of the coating process.

9. A device according to claim 8, wherein the pivot axis lies in a vertical longitudinal center plane of the shaped tool, or in the case of an arrangement including multiple coating tools, in a vertical symmetry plane of the device running between two coating tools.
